(19) United States
(12) Patent Application Publication
(10) Pub. No.: US 2013/0239459 A1
(43) Pub. Date: Sep. 19, 2013

(54) FISH HOOK

(71) Applicant: Howard Rosenberg, Ft. Lauderdale, FL (US)

(72) Inventor: Howard Rosenberg, Ft. Lauderdale, FL (US)

(21) Appl. No.: 13/847,332

(22) Filed: Mar. 19, 2013

Related U.S. Application Data
(60) Provisional application No. 61/612,463, filed on Mar. 19, 2012.

(51) Int. Cl. A01K 83/06

(52) U.S. Cl. CPC A01K 83/06
USPC 43/44.2

(57) ABSTRACT

Disclosed is an improved fish hook having a barb placed between the lower bend and the vertical climb of the shank. The positioning of the barb is strategically positioned a distance from the sharpened point thereby incurring the advantages of a barbless fish hook in combination with the advantages of a barbed fish hook.

### PRIORITY CLAIM

In accordance with 37 C.F.R. 1.76, a claim of priority is included in an Application Data Sheet filed concurrently herewith. Accordingly, the present invention claims priority under 35 U.S.C. §119(e), 120, 121, and/or 365(c) to U.S. Provisional Application No. 61/612,463, entitled “IMPROVED FISH HOOK”, filed Mar. 19, 2012. The contents of which the above referenced application is incorporated herein by reference.

### FIELD OF INVENTION

This invention relates to the field of fishing and more particularly to an improved fish hook having a strategically positioned barb.

### BACKGROUND OF THE INVENTION

The use of fish hooks is probably one of the oldest inventions known used to capture fish. One end of the fish hook is sharpened to a point for ease of piercing fish skin. The opposite end of the fish hook is attached to a flexible line for use in retrieval of the captured fish.

A fish hook catches the fish by either hooking them in the mouth or snagging the body of the fish. There is an enormous variety of fish hooks varying in sizes, designs, shapes, and materials. Fish hooks are manufactured for a range of purposes from general fishing to extremely limited and specialized applications and may hold various types of artificial, processed, dead or live bait to act as the attractant of fish prey.

Most quality fish hooks are covered with some form of corrosion-resistant surface coating. Corrosion resistance is required not only when hooks are used, especially in saltwater, but while they are stored. Additionally, coatings are applied to color and/or provide aesthetic value to the hook. At a minimum, hooks designed for freshwater use are coated with a clear lacquer, but hooks may also be coated with gold, nickel, Teflon, tin and different colors.

Many factors contribute to hook design, including corrosion resistance, weight, strength, hooking efficiency, and whether the hook is being used for specific types of bait, on different types of lures or for different styles of flies. For each hook type, there are ranges of acceptable sizes. For all types of hooks, sizes range from 32 (the smallest) to 24/0 and special larger sizes for shark fishing (the largest).

Commonly referred to parts of a fish hook are: its point—the sharp end that penetrates the fish's mouth or flesh; the barb—the projection extending backwards from the point, that secures the fish from unhooking; the eye—the end of the hook that is connected to the fishing line or lure; the bend and shank—that portion of the hook that connects the point and the eye; and the gap—the distance between the shank and the point. In many cases, hooks are described by using these various parts of the hook. Example: Wide gap, 2X Long Shank, Hollow Point, Turned Down Ring Eye Bait hook. Contemporary hooks are manufactured from carbon steel, steel alloyed with vanadium, or stainless steel. Traditionally a barb is placed directly after the pointed end with the belief that the barb makes it difficult for the fish to become loose while the fish is being drawn to the fisherman. In reality, holding pressure on the fish while hooked along the bend of the hook holds the fish in position. “Tight lines” is an expression well known in the field calling the need to keep the line taught with the fish at the bend.

The barb presents a large disadvantage in that it is so close to the point that it can inhibit attachment to a fish unless the fish hook is firmly set, allowing the barb to pass through the skin of the fish. A further disadvantage is that the barb is so near the pointed end that it presents the fish with an opportunity to dislodge the hook. Further, a barb located next to the sharpened end is difficult to unhook from a fish as the hand must be placed right next to the mouth of the fish during removal making it intimidating to the angular if the fish continues to move.

Having the barb near the end can result in yet another disadvantage, namely an angler who accidentally impales himself with the sharpened point may also engage the barb making it difficult to withdraw. While fish hook(s) barbs are suppose to have a primary function of preventing the hook from exiting the fish, the barb does not assist while the fishing line is being drawn. Rather, the barb only operates as an impediment to pull the hook over the sharpened end which is typically found when an angler impales himself and the barb passes through the skin.

Although single barb hooks are commonly available, some hooks have been devised that include one or more piercing projections, in addition to the commonly provided single barb. In U.S. Pat. No. 523,988 to Martin, issued Aug. 7, 1894, a combination of a single barb with one or more smaller barbs is disclosed. The smaller barb(s) are located forward of the single barb and relatively more adjacent to the penetrating point or tip of the fish hook.

U.S. Pat. No. 620,896 to Edgar, issued Mar. 14, 1899 and U.S. Pat. No. 2,233,863 to Driscoll Mar. 4, 1941 disclose a number of unaligned barbs that are located along opposite or different parts of the fish hook but are adjacent to the penetrating point of the hook.

U.S. Pat. No. 1,717,190 to Coleman, issued Jun. 11, 1929 and U.S. Pat. No. 666,309 to Fiege, issued Jan. 22, 1901 discloses show multiple barbs connected to separate sections of the fish hook, which sections are joined to a common portion of the fish hook.

U.S. Pat. No. 2,962,833 to Stinson, issued Dec. 6, 1960 discloses a number of burrs bent at different angles for use in holding bait.

U.S. Pat. No. 2,906,054 to Morehead, issued Sep. 29, 1959 discloses a large number of splines are disposed surrounding the tip of the fish hook and adjacent to portions thereof. The splines are formed at different angles along the length of the tip.

U.S. Pat. No. 2,266,725 to Andrews, issued Dec. 23, 1941 discloses a double barb fish hook in which a second barb is located a significant distance from the tip of the fish hook and along the shank thereof.

U.S. Pat. No. 2,501,210 discloses a composite fish hook having a swivel-mounted spring-charged barb arm in a latch arrangement that is released when the angler pulls on a short piece of line that is disposed at the shank of the hook.

U.S. Pat. No. 2,841,914 relates to barbless fish hooks which are easy to disengage from caught fish, enabling the same to be returned uninjured to the water.

In the prior art there are fish hooks with hinged and otherwise rotatable barbs that are moved to allow for easier removal of the fish hook from the mouth of a fish. With one prior art fish hook disclosed and claimed in U.S. Pat. No. 3,505,756 the barb is literally hinged.

U.S. Pat. No. 4,028,838 reveals various fish-hook configurations characterized by constricted throat sections as distinguished from reverse-acting barbs, whereby improved holding power is had without the use of barbs that complicate the removal of the hook and increase damage to the fish.

U.S. Pat. No. 4,060,928 is directed to the provision of fish hooks that are caused to rotate within a fish mouth, thereby to prevent hooking the fish in the soft side portion of the mouth.

What is lacking in the art is a fish hook having a barb strategically positioned from the sharpened point.

### SUMMARY OF THE INVENTION

Disclosed is an improved fish hook having a barb located at a position forward of dead center and directly before the vertical climb on the shank toward the point. The instant invention separates the barb and its function of any known fishing hook. The hook of the instant invention does not have a barb near or involved with any point or causing any impediment when passing through the fish skin, jaw, muscle hinge area or other body parts. The instant invention strategically places a barb in contact with the fish only when complete hook penetration has occurred, and holds that part of the fishes body as long as the angler keeps line pressure against the fish.

An objective of the instant invention to place the barb at a location that permits uninhibited penetration of the sharpened point in a manner similar to a barbless hook.

Yet another objective of the instant invention is to teach the use of a molded hook having a radius at the apex or base of the barb to eliminate an otherwise weak link.

Another objective of the instant invention is to position the barb directly before the vertical climb which lessens the distance between the bend and the barb to lessen straight wire dislodgement.

Still another objective invention of the invention is to provide a fish hook that will not impale an angler with the barb. In this embodiment the barb is located remotely from the sharpened end wherein the angler can simply withdraw the sharpened end as the barb has not engaged the skin.

Another objective of the instant invention to place the barb at a location that improves the benefit of the barb through positioning wherein the barb prevents the fish from dislodging or throwing the hook to escape sliding along the length of the fish hook.

Other objectives and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objects and features thereof.

### BRIEF DESCRIPTION OF THE DRAWINGS

FIG. 1 is a perspective view of the instant invention.

FIG. 2 is a side plane view thereof;

FIG. 3 is an enlargement of the barb taken along lines 3-3; and

FIG. 4 is a front plane view.

### DETAILED DESCRIPTION OF THE PREFERRED EMBODIMENT

Now referring to the figures in general, set forth is the fish hook 30 of the instant invention having a first end for use in attachment to a flexible line, not shown, preferably in the form of an eye loop 32. Alternative the eye loop can be replaced with a spiral loop as disclosed in the Applicant's U.S. Pat. Nos. 5,317,736 and 5,809,677 the contents of which are incorporated herein by reference. A shank 34 depends from the eye hook 32 having a lower bend 36 in a similar format as the conventional fish hook wherein a fish that is caught on the fish hook reside in the lower bend 36 during retrieval. After the lower of the bend 36, a barb 42 is located directly before the vertical climb 38. The positioning of the barb 42 is critical to this invention as it must be strategically positioned allowing the lower bend to hold the fish, and the barb to inhibit movement of the fish along the vertical climb. The barb 42 has an upper curved surface 50 and a lower flat surface 52. The lower flat surface positioned to form a plane that is perpendicular to the shank 34. The fishhook structure positions the shank 34 substantially parallel to the vertical climb section 38 with the lower bend section 36 forming a U-shaped curved therebetween.

Placement of the barb 42 before the vertical climb 38 provides the advantage of allowing uninhibited insertion from the sharpened end 42 through the vertical climb 38 to engage the fish. Further, as the stated distance between the barb 42 and the sharpened point 40 is increased, should angler impale themselves, the distance is now increased so much that the barb 42 no longer becomes a factor and the fish hook can be easily removed without considerable damage.

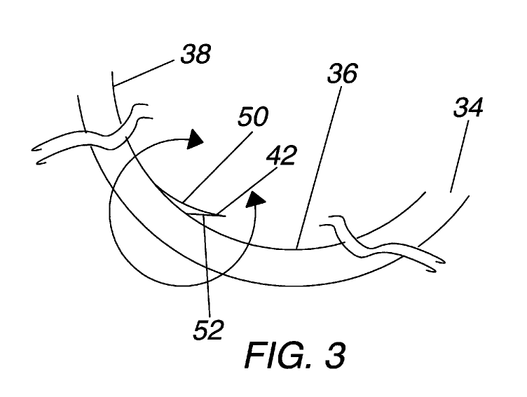

The placement of the barb 42 must be strategically positioned between the lower bend 36 and the vertical climb 38 as the shape of the hook engages the fish and actually provides a final set directly before the side of the skin or bone thereby inhibiting disengagement. If the barb is placed to high upon the vertical climb then the result is a conventional hook having all of the aforementioned disadvantages. If the barb is placed on the lower bend, the barb can cause further injury to the fish if the barb is not set into or against the skin. The use of an upper curved upper surface 50 allows ease of an engagement with the fish and the lower flat surface 52 placed perpendicular to the shank 34 allows for a secure attachment and is less damaging to the fish since a fish can otherwise slide up the shank toward the tip and restrike a conventional placed barb. The result is tears to the fish skin as it attempts to dislodge the hook. While the preferred embodiment is to have a barb 42 with a lower flat surface 52 placed perpendicular to the shank, other types of barbs can also be employed. By placing the barb 42 directly before the vertical climb 38, the fish is no longer able to use the length of uninhibited wire between the bottom of fish hook, show as the bend 36 in FIG. 3, and the position of a conventional barb to work on dislodgement of the fish hook. The skin of a fish mouth is not an inch wide so it can be envisioned that once a fish is hooked, the placement of the barb a distance from the lower bend operates to prevent dislodgement but does not operate to save the fish from harm. In many instances a fish is caught and released as a sport, the fisherman do not wish to harm the fish and during the event. By proper placement of the barb, the thickness of the fish mouth is taken into account and the barb is used to maintain the hook is direct contact with the mouth which results in less stress to the fish, and less opportunity for the fish to escape. Further, conventional barbs are cut into the hook causing the barb to create a weak point. The barb 42 of the instant invention is not cut into the hook, rather the barb is formed into the hook during the stamping stage.

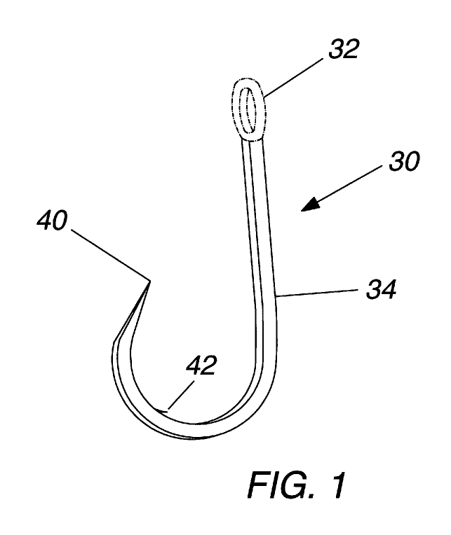

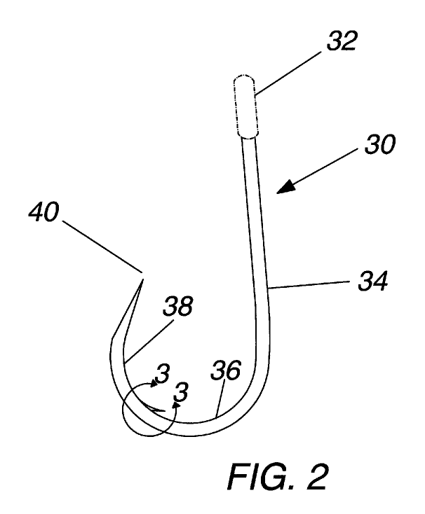

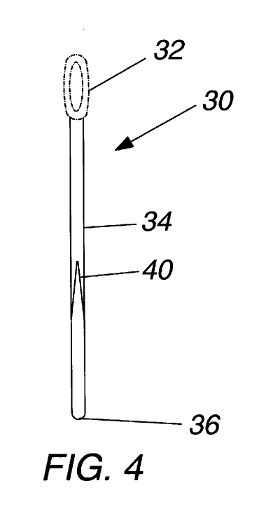

Variation to the type of barbs employed include the use of a knife edge barb, opti-angle needle barb, micro barb, short barbs, curved in barbs, reversed barbs, and kirbed barbs. Each of these barbs are known in the art, however, they are placed adjacent to the sharpened point of the fish hook. A molded hook includes a radius at the apex or base of the barb to eliminate an otherwise weak link in the hook. The hook can be made from square stock as shown in FIG. 1 or round stock as shown in FIGS. 2-4. The actual size of a fish hook device is determined by the type of fish sought and the construction of the fish hook is then dependent upon the distance between the sharpened point and the bend, also referred to as the throat. As the size of the fish may vary, larger hooks have increased throats or gaps, but the placement of the barb before the vertical climb remains most applicable. For instance, a hook having a throat that is 2 inches deep does not require the targeted fish to have skin that is 2 inches thick, rather the thickness of the fish along the mouth does not change proportionately with the size of the hook. Thus, placement of the barb directly before the vertical climb operates for any size fish. Further defined, placement of the barb directly before the vertical climb positions the barb on the lower bend at a position that is selected to accommodate the thickness of the fish skin. The lowest position on the bend of the hook is where the fish is held and for this reason the barb is strategically placed in the direction of the point. The placement of the barb on before the vertical climb removes all interference with the sharpened point penetrating the fish. In effect placement of the barb operates as barbless hook for ease of penetration. However, the barb location now works to keep the fish on the hook along the lower bend until removed.

It is further submitted that the positioning of the barb along the inside of the vertical climb is much less damaging to the fish during removal. The angler is able to press against the shank to allow ease of overcoming the barb during removal. It should be emphasized that by placing the barb 42 directly before the vertical climb 38, the fish is no longer able to use the length of uninhibited wire between the bottom of the bend 36 and position of the conventional barb to work on dislodgement of the fish hook.

While a single embodiment of the instant invention is disclosed herein, it is to be understood that the disclosed embodiment is merely exemplary of the invention, which may be embodied in various forms. Therefore, specific functional and structural details disclosed herein are not to be interpreted as limiting, but merely as a basis for the claims and as a representation basis for teaching one skilled in the art to variously employ the present invention in virtually any appropriately detailed structure.

All patents and publications mentioned in this specification are indicative of the levels of those skilled in the art to which the invention pertains. All patents and publications are herein incorporated by reference to the same extent as if each individual publication was specifically and individually indicated to be incorporated by reference. It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A fishhook structure comprising a shank, means at one end of said shank for attaching to a flexible fishing line, said shank having a lower bend section and vertical climb section ending in a sharpened end point at the other end of said shank; and a barb positioned adjacent said lower end and directly before said vertical climb section.

2. The fishhook structure according to claim 1 wherein said shank is positioned substantially parallel to said vertical climb section with said lower bend section forming a U-shaped curved therebetween.

3. The fishhook structure according to claim 1 wherein said barb has a substantially flat lower surface, said lower surface positioned perpendicular to said shank.

4. The fishhook structure according to claim 1 wherein said barb is selected from the group consisting of: knife edge barb, opti-angle needle barb, micro barb, short barb, curved in barb, reversed barb, and kirbed barb.

5. The fishhook structure according to claim 1 wherein said barb is foamed into the hook said lower bend section.
